(19) United States
(12) Patent Application Publication
(10) Pub. No.: US 2017/0317886 A1
(43) Pub. Date: Nov. 2, 2017

(54) Systems and Methods for Configuring a Radio Access Network Process in a Communications Network

(71) Applicants: Philippe LEROUX, Ottawa (CA); Aaron James CALLARD, Ottawa (CA)

(72) Inventors: Philippe LEROUX, Ottawa (CA); Aaron James CALLARD, Ottawa (CA)

(73) Assignee: Huawei Technologies Co., Ltd., Shenzhen (CN)

(21) Appl. No.: 15/144,303

(22) Filed: May 2, 2016

(51) Int. Cl. H04L 12/24; H04L 12/911

(52) U.S. Cl. CPC H04L 41/0823; H04L 41/12; H04L 47/82

(57) ABSTRACT

A method for configuring a radio access network (RAN) process onto a communications network having a plurality of nodes is disclosed. The method includes converting the RAN process into a service function chain having a plurality of functions, and distributing each function of the plurality of functions between the plurality of nodes in the communications network.

### FIELD OF THE INVENTION

The present invention pertains to the field of network communications, and in particular towards systems and methods for configuring a radio access network process in a communications network.

### BACKGROUND

Communication networks may include a plurality of nodes that are linked together in order to process and transmit data between certain nodes in response to a service request. The processing functions of the various nodes are typically fixed during network implementation, and not readily adaptable to changing needs and available resources of the communications network. Some functions may also be redundant and/or unnecessary in order to carry out certain service requests, causing processing inefficiencies. This problem is exacerbated as more service requests are processed, which effectively increases the backhaul processing required of the network, and may result in increased delays or round trip times (RTTs) in order to carry out a given service request. Accordingly, there is a need for a system and method that at least partially addresses one or more of the above limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide an improved system and method for configuring a radio access network (RAN) process in a communications network.

In accordance with embodiments of the present invention, there is provided a method for configuring a RAN process in a communications network having a plurality of nodes. The method comprising converting the RAN process into a service function chain having a plurality of functions; and distributing each function of the plurality of functions between the plurality of nodes.

In accordance with embodiments of the present invention, there is provided a controller for configuring a radio access network (RAN) process in a communications network having a plurality of nodes. The controller comprising: a processor; an input interface coupled to the processor for receiving information indicative of the RAN process and the plurality of nodes of the communications network; a memory communicatively coupled to the processor and having stored thereon instructions which when executed by the processor causes the controller to convert the RAN process into a service function chain having a plurality of functions, and determine placement of each function of the plurality of functions between the plurality of nodes of the communications network; and an output interface for sending signals to the communications network indicative of each of the plurality of functions and their placement in the communications network.

In accordance with embodiments of the present invention, there is provided a method for configuring a radio access network (RAN) process in a communications network having a plurality of nodes. The method comprises generating a Service Function Chain (SFC) descriptor function for defining a SFC having a plurality of functions; providing the SFC descriptor function to a node in the communications network to convert the RAN process into the SFC according to the SFC descriptor function, and distribute each function of the SFC between the plurality of nodes.

### BRIEF DESCRIPTION OF THE FIGURES

Further features and advantages of the present invention will become apparent from the following detailed description, taken in combination with the appended drawings, in which:

FIG. 1 illustrates a communications network, according to an embodiment;

FIG. 2 is a functional diagram of a RAN process deployed on a network node, according to an embodiment;

FIG. 3 illustrates a method for configuring a RAN process in a communications network, according to an embodiment of the present invention;

FIG. 4 illustrates the RAN process shown in FIG. 2 converted into a service function chain comprising a plurality of functions, according to an embodiment of the present invention;

FIGS. 5A-C illustrate a RAN process converted into various service functions chains, according to an embodiment of the present invention; and

FIG. 6 illustrates a hardware schematic of a controller, according to an embodiment of the present invention.

It will be noted that throughout the appended drawings, like features are identified by like reference numerals.

### DETAILED DESCRIPTION

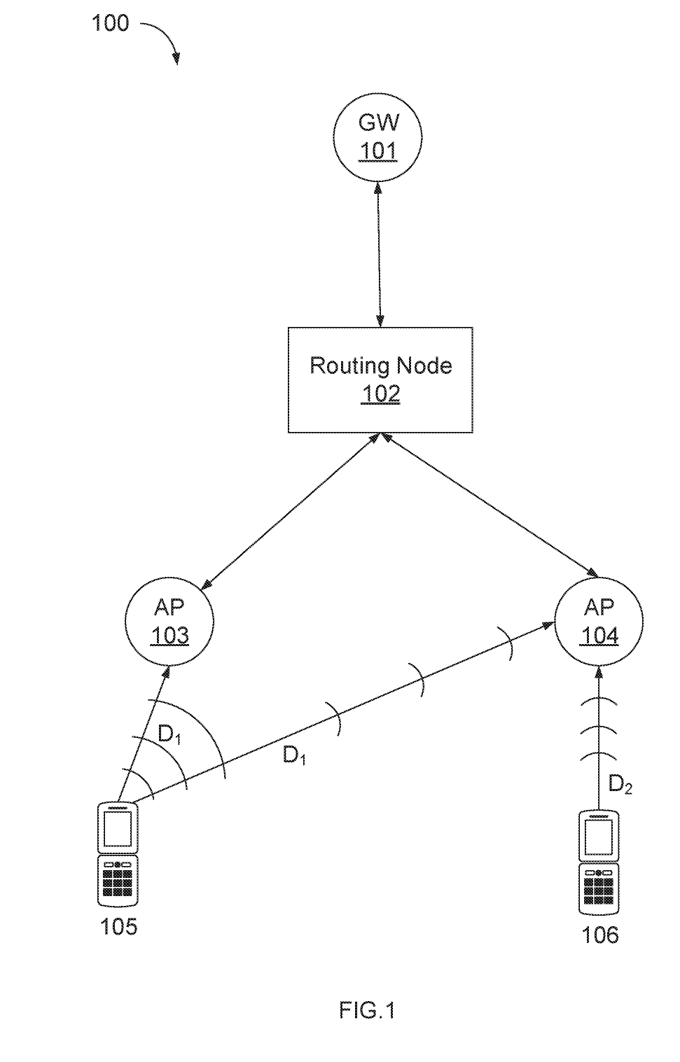

Communication networks typically comprise a plurality of nodes (such as access points) each operable to perform a set of radio access network (RAN) processes to carry out the necessary processing, scheduling, and transmission to complete a service request associated with a particular data flow. This may be illustrated with reference to FIG. 1, where there is shown a communications network 100 according to an embodiment. The communications network 100 comprises a plurality of nodes, including a gateway node 101, a routing node 102, a first access point AP 103, and a second access point AP 104, each of which are communicatively coupled as shown. A first user equipment UE 105 is served by the first access point 103, while a second UE 106 is served by the second access point 104. The communications network 100 is operable to handle various service requests comprising flows of data sets from various UEs to across the network 100, or to the gateway node 101 for transmission to an external destination. For example, a first service request R₁ may comprise a flow of data set D₁ from UE 105 to gateway node 101, and a second service request R₂ may comprise a flow of data set D₂ from UE 106 to gateway node 101. In order to carry out such requests, AP's 103, 104, which receive data sets D₁, D₂ from UEs 105, 106, respectively, must each include RAN processing functionality in order to carry out the required encoding, decoding, and scheduling functions associated with a given service request. Additionally, the transmission of data sets D₁, D₂ may cause interference, in which APs 103, 104 must then cooperate in order to recover the intended data set. As shown in FIG. 1, AP 104 receives a coupled data set of (D₁+D₂) from interference received from D₁ Accordingly, the RAN process of AP 104 must then independently retrieve D₁ from AP103 (via routing node 102, for example) in order to recover D₂ from the coupled data set it received.

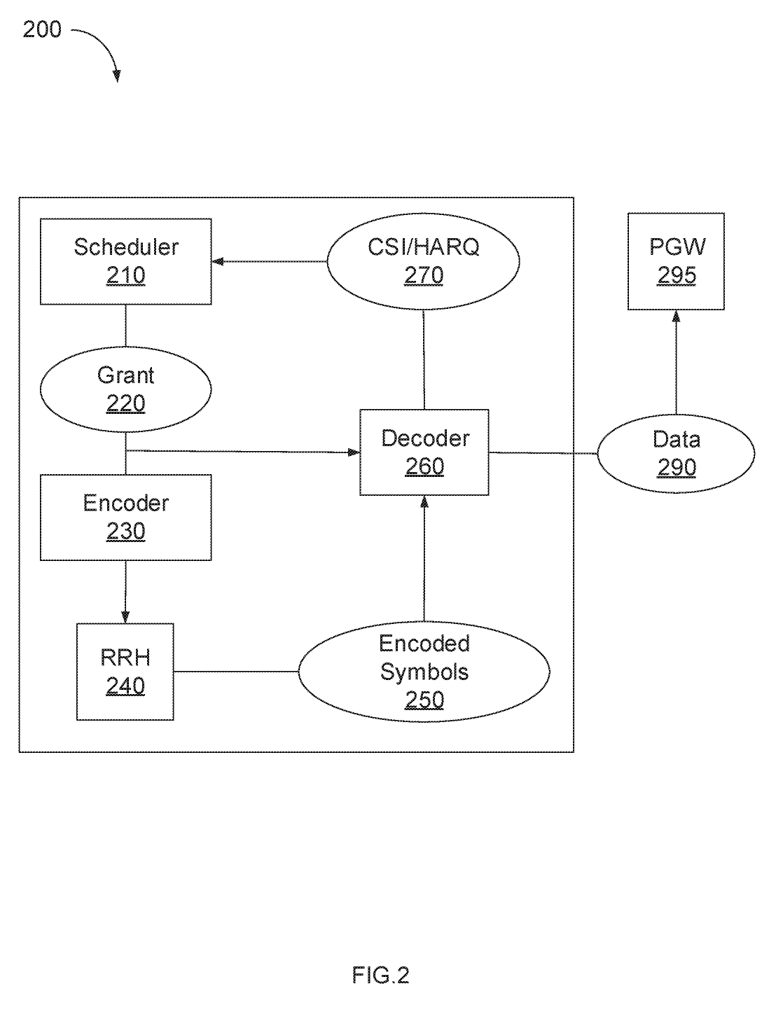

Referring to FIG. 2, there is shown a functional diagram of a node 200 operating under a RAN process to receive a data set from a UE in an uplink direction, process the data set, and deliver the data set to a packet gateway 295, according to an embodiment. For example, the node 200 may comprise any of APs 103, 104 of FIG. 1 in certain situations. As shown in FIG. 2, the node 200 includes a scheduler function 210, a grant function 220, an encoding function 230, a radio resource head (RRH) function 240, a symbol encoding function 250, a decoding function 260, and a CSI/HARQ function 270. In some embodiments, each of these functions are required in order to receive a data set, and perform the necessary processing (i.e. encoding, decoding, etc.) in order to provide a conditioned data set 290 for transmission to a packet gateway (PGW) 295. While not shown, a RAN process to transmit data in the downlink direction may appear very similar, and would be understood by a person skilled in the art.

However, in some cases (for example, for certain service requests, or for certain data sets) some of the RAN functions shown in FIG. 2 are unnecessary, redundant, and/or superfluous. This may result in unnecessary processing burdens placed upon the node 200 with respect to certain service requests, data flows, or data sets. Further the RAN functionality within node 200 is typically fixed during network implementation, and not readily adaptable to changing network needs and available resources of the communications network. The accumulation of these limitations may result in increased processing times, backhaul delays, and a reduced quality of service (QoS) associated with a given service request. Accordingly, there is a need for selectively distributing different functions of a RAN process across nodes of a communications network, in order to help alleviate processing burdens of individual nodes, and to help improve overall network efficiency.

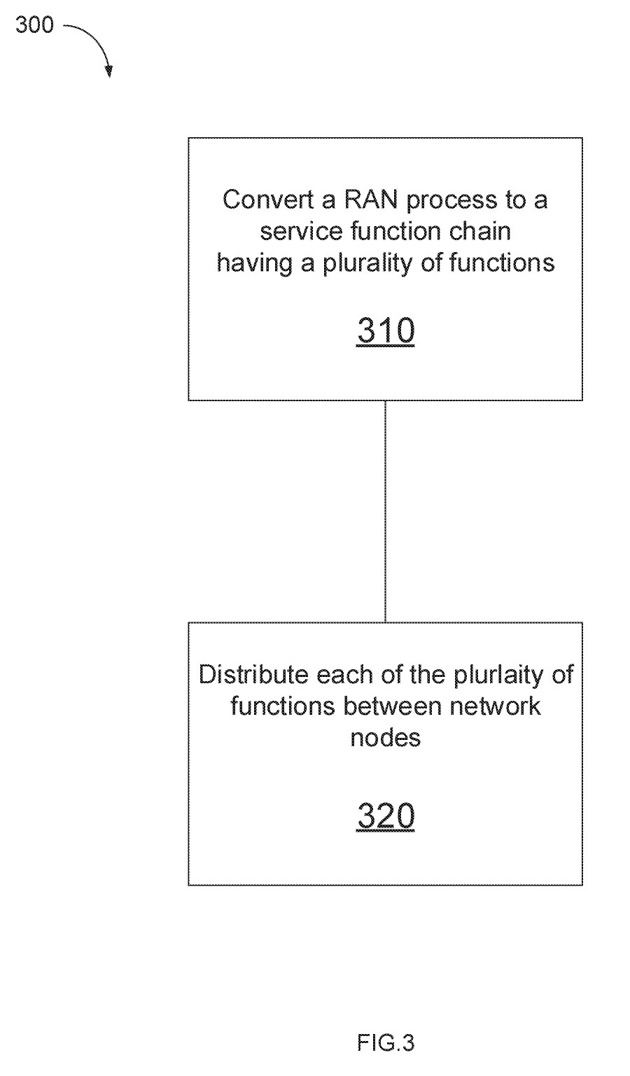

Referring to FIG. 3, there is shown a flow chart 300 illustrating a method for configuring a RAN process in a communications network, according to an embodiment of the present invention. For example, the method may be used for receiving, encoding, and transmitting the second data set D₂ of FIG. 1 to the gateway node 101 while still adhering to a given RAN process. At step 310, a RAN process is converted to a service function chain (SFC) having a plurality of functions. As understood by persons skilled in the art, a SFC is an ordered set of functions, each of which may be instantiated across multiple network nodes; data flows may then be steered according to the order of the SFC in order to process the data flow in accordance with the SFC. This will be described in further detail below. At step 320, each of the plurality of functions (of the SFC) are distributed between the plurality of nodes of the communications network. Referring to FIG. 1 for example, if the SFC comprises first, second, and third functions, the first function may be distributed to node 103, the second function to node 102, and the third function to node 104 of communications network 100. Accordingly, successive data flows may then be routed between the nodes of the communications network according to the SFC, in order to fulfil the processing requirements of the RAN process across multiple nodes, instead of through a single node. This may help alleviate the processing burden otherwise bourn upon any single node, and/or reduce backhaul congestion in the communications network 100.

Further regarding step 310 of FIG. 3, the RAN process may be converted to a SFC by dividing its component functions into distinct or discrete functional components of the SFC. For example, some RAN processes may include decoding, encoding, and scheduling functions, each of which may be formulated as a separate function of the SFC.

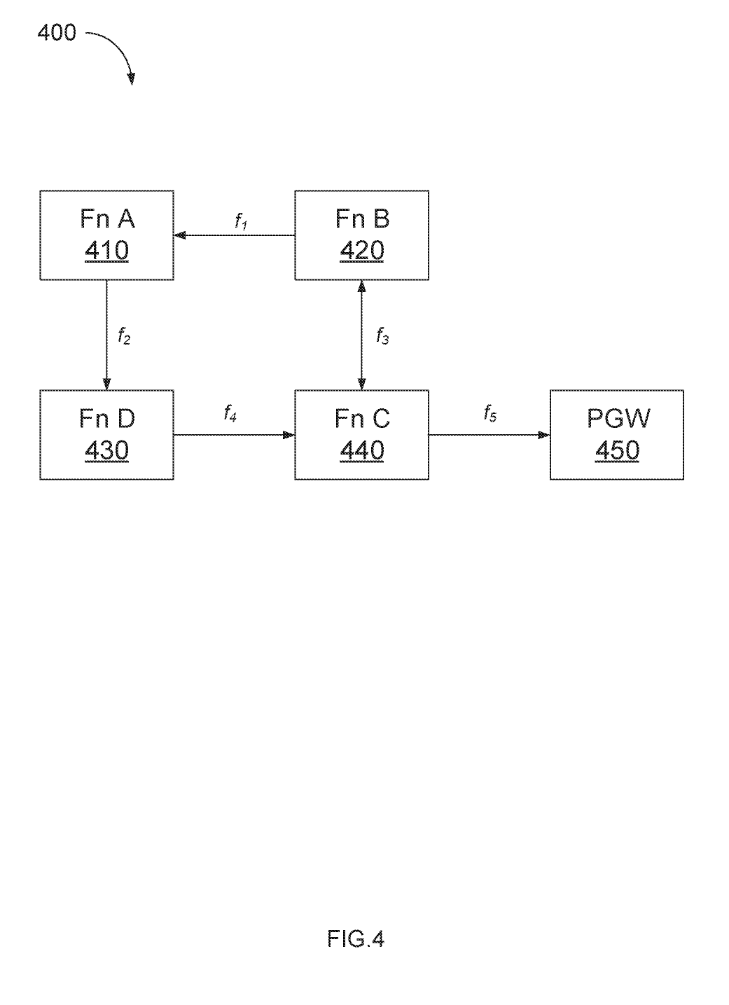

FIG. 4 illustrates an SFC 400 converted from a RAN process, according to an embodiment. For example, SFC 400 may be converted from the functional RAN process deployed on node 200 of FIG. 2, with certain functions omitted according to an SDT algorithm. For example, function A 410 may correspond to the scheduling function 210 of FIG. 2, function B 420 may correspond to the grant function 220, function C 440 may correspond to the encoding function 230, and function D 430 may correspond to the decoding function 260. Accordingly, the RRH 240, encoded symbols 250, and CSI/HARQ 270 functions of the RAN process on node 200 of FIG. 2 are deemed unnecessary in this example and thus omitted in SFC 400.

In certain embodiments, functions in an SFC can be derived from a function descriptor, such as an SFC descriptor; these may also be referred as “blueprints” or a Virtual Network Function (“VNF”) forwarding graph descriptor. Additional examples of function descriptors may be found at “https://github.com/nfvlabs/openmano/wiki/openmano-descriptors”, for example. For instance a Fast Fourier Transform (“FFT”) can comprise a RAN processing function having certain processing requirements, (or alternatively a delay to processing capability mapping), Random Access Memory (“RAM”) requirements, and a description of the input and output of the function. An SFC descriptor is a function that can be used to define a SFC with a plurality of functions, and describes the requirements of each of the functions. For example, for an SFC comprising 3 functions: A->B->C, the SFC descriptor can describe the resource requirements for each function. In certain embodiments, an SFC descriptor may be passed onto a functional entity (such as a node, access point, Virtual Network Function (“VNF”) etc.) and used to derive an SFC from a RAN process, with each function of the SFC meeting the requirements provided by the SFC descriptor. The requirements set out by an SFC descriptor for an SFC and its functions, may comprise any resource such as computation, memory, storage or communication. Further, the requirements can be either “hard” (e.g. invariable) or “soft” (assuring a certain amount of performance, with a certain amount of resources) as understood by those skilled in the art.

In certain embodiments, the SFC may comprise a collection of VNFs, including descriptions of how those VNFs' connect (e.g. order of the VNFs in the SFC). The SFC may be implemented using structures similar to European Telecommunications Standards Institute's (“ETSI”) SFC (see https://datatracker.ietf.org/wg/sfc/documents/, for example) or through other approaches using different transport layers between the network functions (virtual or otherwise).

The processing requirements of each VNFs can be expressed as hard requirements (i.e. which must be fulfilled) or as soft requirements (i.e. which may be satisfied or partially satisfied). With Reference to the RAN process operating on node 200 in FIG. 2, for example, several SFCs may be derived therefrom. For example, a first SFC may comprise the functions: RRH 240, and decoder 260, for transmitting to the packet gateway 295. A second SFC may comprise the functions: decoder 260, scheduler 210, and RRH 240. A third SFC may comprise the functions: decoder 260, scheduler 210, and decoder 260.

In other embodiments (not shown), an SFC may be derived from a RAN process via a virtual network forwarding graph, as understood by those skilled in the art.

In certain embodiments, the conversion of a RAN process into an SFC having a plurality of functions is dependent on the implementation considered and the time of network deployment. For example, in the course of encoding the RAN process, many different sub processes may be produced. This may be performed to enable low level orchestration of individual sub-processes, each encompassed as a individual addressable object. Each sub process may therefore map to a certain function of the SFC in step 310, for example.

As noted above, the SFC may comprise a plurality of functions mapped from component sub-processes of a RAN process. In some embodiments (not shown) one or more of these functions may be expressed as a single VFN. For example, functions of the SFC may include: Quadrature Amplitude Modulation (QAM) mapping, Precoding, Encoding, Decoding, Protocol layers, Channel estimation, FFT, Modulation (Orthogonal Frequency Division Multiplexing (OFDM), filtered-OFDM, offset quadrature amplitude modulation (OQAM), Sparce Code Multiple Access (SCMA), Code Division Multiple Access (CDMA), and so forth)

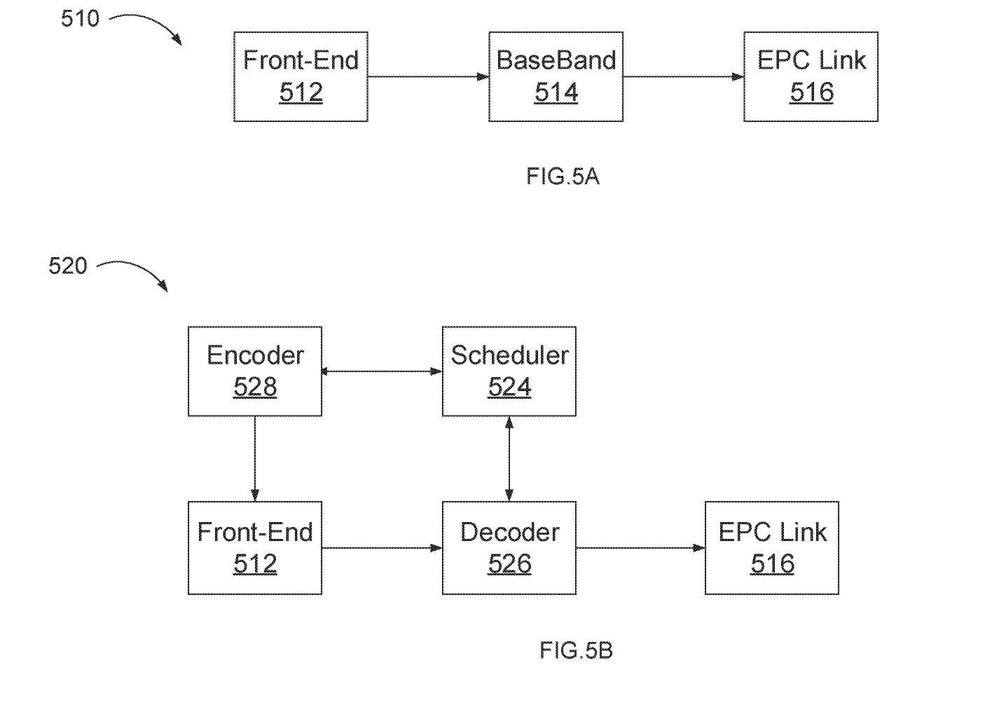

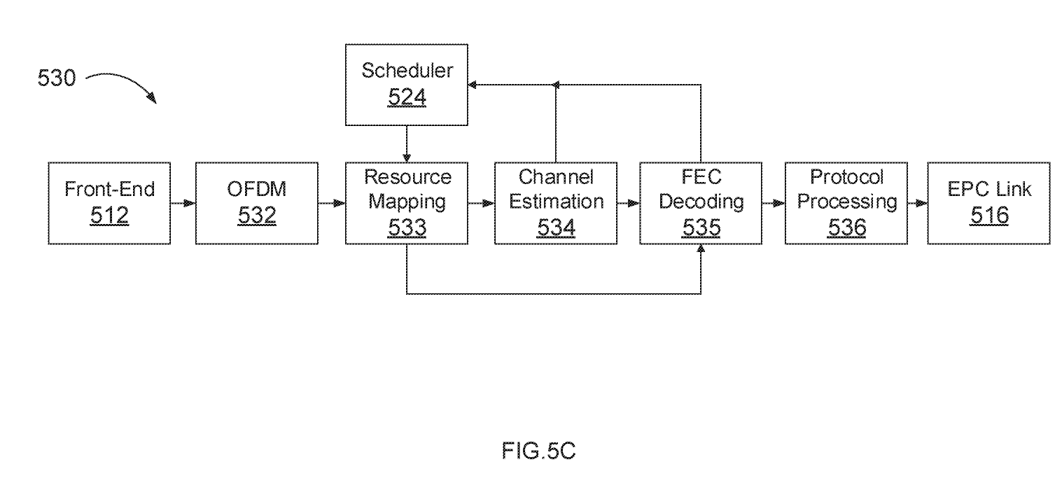

Referring to FIGS. 5A-C, there are shown various examples of SFCs 510, 520, 530, converted from a RAN process that processes an uplink signal, according to various embodiments. For example, the RAN process may be specifically directed towards uplink processing of a Long Term Evolution (LTE) waveform performed at an eNodeB. As shown in FIG. 5A, SFC 510 includes a Front-End (Antenna) function 512 which receives over-the-air signals, and coverts the signals into digital data. This function may also be represented in SFC 510 as a fixed source of data, wherein the location of the traffic remains unchanged through instantiation of a different virtual machine. A Baseband function 514 performs all data processing within a single function, and may contain several sub-functions that may, or may not be known to other entities of the communications network. Baseband function 514 may have processing requirements for different nodes and/or associated processors, and connectivity requirements between them (e.g. backplane delays, etc.). Finally, an External Packet Core (EPC) Link function 516 provides any requirements for a connection to an EPC. For example, for establishing certain connections (i.e. 75 Mbps connection to a gateway node, and 5 Mbps to mobility management entity).

FIG. 5B illustrates another SFC 520 derived from the same RAN process as above in FIG. 5A. However, SFC 520 differs from SFC 520 in that it separates functions along a data plane and control plane, as understood by these skilled in the art. Specifically, SFC 520 further includes a decoder function 526 that converts data from Front-End 512 and converts it to fully decoded traffic recognizable by the network. It may also provide Channel State Information (CSI), decoder states, and buffer statuses to the Scheduler 524, and receives instructions from the scheduler 524 to perform certain decoding steps. An Encoder function 528 converts information from the network (EPC or otherwise) and converts the information into over-the-air signals. It may also provide channels (such as PUCCH), and receive instructions from the scheduler 524 to perform certain decoding steps. Finally, Scheduler 524 receives data from the decoder 526 and encoder 528, and instructs both functions as to the appropriate actions to perform.

FIG. 5C illustrates another SFC 530 derived from the same RAN process as above in FIG. 5A. In addition to those functions already described above, SFC 530 further includes an OFDM (Orthogonal Frequency Domain Multiplexing) demodulator 532, which receives antenna data and converts it into a signal space having orthogonal resources. A resource mapping function 533 divides monolithic data into different subsections representing different FEC (Forward Error Correction) codes, where each FEC code can be decoded independently. The resource mapping function 533 can also separate the pilot tones for channel processing. A channel estimation function 534 receives pilot tones (from resource mapping function 533) and estimates a channel for different users/sequences. An FEC decoding 535 function receives channel estimates and data estimates of FEC codes, and converts them into decoded data blocks. A protocol processing function 536 performs various standard protocol steps on data blocks, such as RLC (Radio Link Control), PDCP (Packet Data Convergence Protocol), etc. Scheduler 524 in this embodiment receives data from various functions (such as Channel estimation 534) and provides instructions for channel grant messages, as well as what actions the various functions should perform (i.e. how the resource mapping occurs, what FEC code to use, what parameters to use for decoding etc.).

In some embodiments, step 310 of FIG. 3 may also include the removal or omission of certain RAN process functions if deemed redundant or unnecessary for a particular data flow, service request, or operation. For example, this determination may be performed according to a software defined topology (SDT) method, which will be described below in further detail. In some embodiments, if there are multiple options for a particular function, each having a different characterization (for example, one option consumes less resources but takes longer, such as in sequential or parallel options,) the choice of which option to use for a particular function may also be made by the SDT.

Further regarding step 320 of FIG. 3, each separate function of the SFC may be distributed amongst different nodes of the communications network, for example, according to a SDT method which decides where to place each function according to a given utility. The SDT may comprise an optimization function which determines the necessity and best placement of each component SFC function within a communications network. The utility may relate to the quality of service (QoS) relating to a given service request to be carried out on the communications network, including but not limited to: data transmission rate, delay, jitter, network traffic, and so forth. In certain embodiments, distributing each component function comprises instantiating each component function as a virtual network function (VNF) in order to meet a given utility objective.

In some embodiments, distribution of each of the SFC functions can be formulated according to a utility function, such as as a convex optimization problem, for example, by presuming a convex utility, stateless functions, and infinitely divisible traffic flows. In one example, consider a SFC which has a convex utility function U(r), where r is a vector of rates connection between the various functions (each represented by a VNF for example). For simplicity we may presume only two functions A and B, but the concept may readily extend to more functions in other embodiments (not shown). Accordingly, there is a single rate r, representing all the traffic going from function A to function B; the traffic leaves one function and enters another. In this way, we can virtually duplicate the function deployed at every node.

For example, we may want to maximize the utility function U(f) for a given flow ƒ.

ƒεN

where the set N reflects the traffic that the network can support. Using an arc based formulation this set can be expressed as

$$∀ n {\sum }_{i ingress of node n} {r}_{i} - {\sum }_{i egress of node n} {r}_{i} = {f}_{n \\} {\sum }_{n} {f}_{n} = f$$

and ƒₙ is the amount of traffic generated or consumed at node n, for flow ƒ. Any node with a non zero value of ƒₙ may have a function instantiated there. This formulation can be extended to consider processing constraints at nodes (g(ƒₙ)≦c, where g(f) is the resources consumed by the function, the delay of traffic in the network and so forth. Alternate solutions may also consider task scheduling (i.e. hypervisor level).

In another example, an SFC, may have two different options for the function B, which we denote as B₁, and B₂. These different options, for example, could reflect a parallel or a sequential implementation of a decoding function, respectively. The utility function may now be represented as U(ƒ_{b1},ƒ_{b2}), where the impact of the different processing delays for each function, is captured inside the utility. Alternatively the utilities may be identical, but the processing delays may be different for each function, which is enforced elsewhere. In certain embodiments (not shown) method 300 of FIG. 3 may further include routing a data flow between the plurality of nodes according to the service function chain. Referring to FIG. 1 for example, if the SFC comprises a first function instantiated on node 103, a second function instantiated on node 102, and a third function instantiated on node 104, then the data flow for D₁ may be routed to node 103, then node 102, and node 104, in order, in order to fulfil the processing requirements of RAN process through the SFC.

In certain embodiments, method 300 of FIG. 3 may be dynamically applied in order to help perform ancillary RAN processes, such as the provision of companion flows between network nodes. As understood by those skilled in the art, a companion flow is a data flow that assists in the processing of a specific data flow, but does not bear direct relevance to the content of the specific data flow.

Referring to FIG. 1 as an illustrative example, if the communications network 100 is serving a first request to receive and encode a first data set D₁ from UE 105 via access point 103, while also serving a second request to receive and encode a second data set D₂ from UE 106, the second access point 104 may receive interference from the transmission of data set D₁ from UE 105, and instead receive a superimposed/coupled data set of (D₁₊D₂). Accordingly, access point 104 would independently require data set D₁ in order to decouple it from the received data set (D₁₊D₂) and recover D₂ to carry out the second request. In this case, a RAN process may be implemented as a SFC on communications network 100 in order to retrieve data set D₁ and provide it to access point 104. For example, the RAN process (and thus corresponding SFC) may include the necessary scheduling, encoding, and routing functions each deployed across nodes 103, 102, and 104 in order to retrieve and transmit data set D₁ from node 103 and provide it to access point 104. Accordingly, method 300 may be dynamically applied for various RAN processes in order to address emerging issues or constraints.

In some embodiments, the utility (i.e. benefit) that the RAN receives from using network resources (compute, forward, store) may change as the traffic in the RAN changes. This may occur due to user mobility, and/or fluctuations in traffic requirements. Higher loading may require advanced joint processing schemes, which consume significantly more network resources. As the benefit fluctuates, the RAN resources may be dynamically repartitioned between multiple RAN nodes (i.e. different eNB's fronthaul) as well as entities from other traffic entirely such as fixed networks, CDN, etc.] Examples illustrating dynamic application of SFC distribution may be found for example, in U.S. Ser. No. 15/050,915, which is herein incorporated by reference in its entirety.

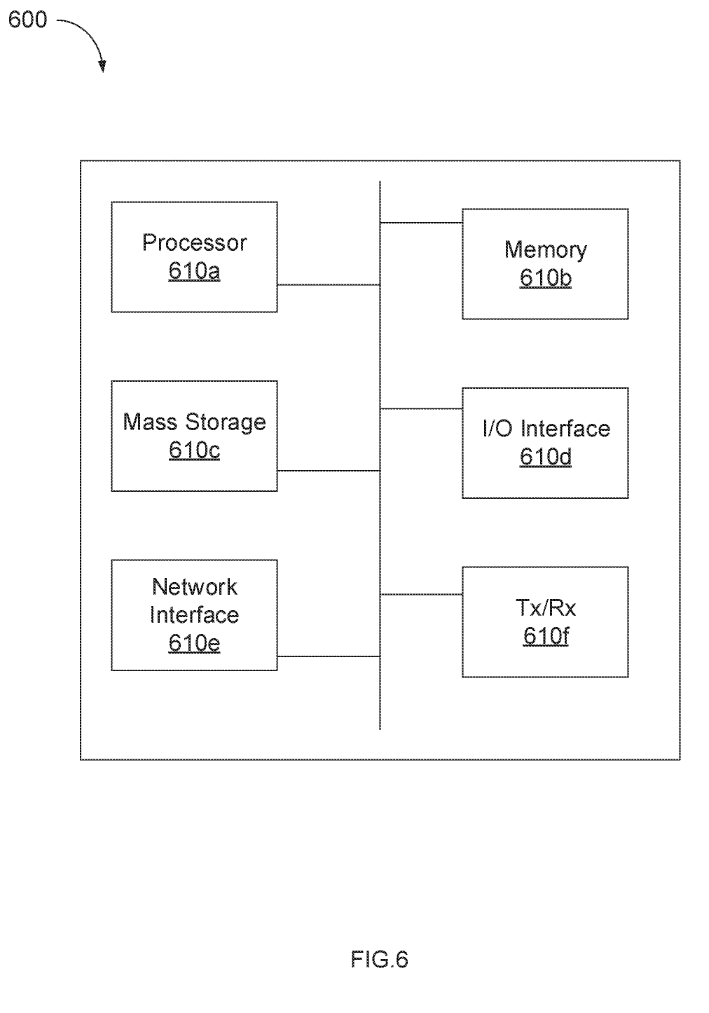

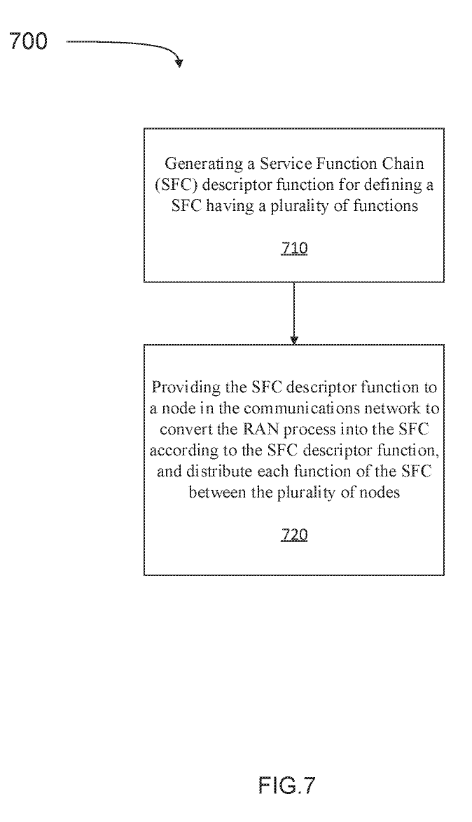

FIG. 6 is schematic diagram of a controller 600 that may perform method 300 in FIG. 3 or method 700 of FIG. 7, according to embodiments of the present invention. For example, the controller 600 may be communicatively coupled to various nodes of a communications network, and be operatively configured to convert a RAN process into a SFC having a plurality of functions, and to transmit and/or assign each SFC function amongst different nodes of the communications network. The controller 600 may also provide signals (to traffic engineering controllers or schedulers, for example) to control the flow of data across network nodes according to the SFC. In certain embodiments, the controller 600 may comprise a network node having traffic engineering and/or scheduling functions deployed therein in order to direct and schedule flows across the network according to a SFC.

As shown in FIG. 6, the controller 600 includes a processor 610a, memory 610b, non-transitory mass storage 610c, I/O interface 610d, network interface 610e, and a transceiver 610f, all of which are communicatively coupled via bi-directional bus. According to certain embodiments, any or all of the depicted elements may be utilized, or only a subset of the elements. Further, the controller 600 may contain multiple instances of certain elements, such as multiple processors, memories, or transceivers. Also, elements of the hardware device may be directly coupled to other elements without the bi-directional bus.

The memory 610b may include any type of non-transitory memory such as static random access memory (SRAM), dynamic random access memory (DRAM), synchronous DRAM (SDRAM), read-only memory (ROM), any combination of such, or the like. The mass storage element 610c may include any type of non-transitory storage device, such as a solid state drive, hard disk drive, a magnetic disk drive, an optical disk drive, USB drive, or any computer program product configured to store data and machine executable program code. According to certain embodiments, the memory 610b or mass storage 610c may have recorded thereon statements and instructions executable by the processor 610a for performing any of the aforementioned method steps described above.

Referring to FIG. 7, there is shown a flow chart 700 illustrating a method for configuring a RAN process in a communications network, according to an embodiment of the present invention. For example, the method may be used by a 3^{rd} party operator separate from the communications network, in order to configure the RAN process onto the network. At step 710, a Service Function Chain (SFC) descriptor function is generated for defining a SFC having a plurality of functions. At step 720, the SFC descriptor function is provided to a node in the communications network to convert the RAN process into the SFC according to the SFC descriptor function, and distribute each function of the SFC between the plurality of nodes. In this way, a 3^{rd} party separate from the communications network (such as an operator) can define the implementation of the RAN process over the network.

In certain embodiments, the SFC descriptor function describes resource requirements for each function of the SFC. The node which receives the SFC descriptor function can thus use these resource requirements in defining each of the functions of the SFC.

In certain embodiments, method 700 can further include receiving parameters from the communications network. The parameters in turn, can be used to generate the SFC descriptor function. For example, the parameters may comprise state information of the communications network, or available processing or transmission (e.g. link capacity or channels) of the communications network. In this way, the resource requirements for each function of the SFC can be tailored according to the available resources in the communications network, in order to improve operational efficiency.

Embodiments of the present invention disclose systems and methods for configuring a RAN process within a communications network, by converting it to a SFC and placing individual functions through different network nodes in a manner which better leverages network resources or improves operational efficiency. Data flows may then be routed throughout the network according to the SFC, in order to process the data flows in a manner still adhering to the RAN process. The data flow may comprise a companion flow, which is an ancillary flow used to assist in the processing of a specific data flow. Use of a SFC based processing method provides a cooperative method that can adapt to changing network needs and requirements. In certain situations, it may reduce backhaul congestion of the network, and more efficiently utilize network resources by allocating respective SFC functions throughout various network nodes.

Unless defined otherwise, all technical and scientific terms used herein have the same meaning as commonly understood by one of ordinary skill in the art to which this invention belongs.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for configuring a radio access network (RAN) process in a communications network having a plurality of nodes, the method comprising:
converting the RAN process into a service function chain having a plurality of functions; and
distributing each function of the plurality of functions between the plurality of nodes.

2. The method of claim 1 further comprising routing a data flow between the plurality of nodes according to the service function chain.

3. The method of claim 1 wherein the RAN process comprises a plurality of RAN functions, and the step of converting the RAN process into a service function chain comprises omitting unnecessary RAN functions with respect to a data flow.

4. The method of claim 1 wherein the step of distributing each function between the plurality of nodes is performed according to a software defined topology (SDT) algorithm.

5. The method of claim 1 wherein the step of distributing each function between the plurality of nodes comprises instantiating each function onto one of the plurality of nodes.

6. The method of claim 1 wherein the step of distributing each function of the service function chain is performed according to a utility function.

7. The method of claim 7 wherein each function of the plurality of functions is us distributed in a way to optimize the utility function.

8. The method of claim 1 wherein the service function chain includes a decoding function, an encoding function, and a scheduling function.

9. A controller for configuring a radio access network (RAN) process in a communications network having a plurality of nodes, the controller comprising:
a processor;
an input interface coupled to the processor for receiving information indicative of the RAN process and the plurality of nodes of the communications network;
a memory communicatively coupled to the processor and having stored thereon instructions which when executed by the processor causes the controller to convert the RAN process into a service function chain having a plurality of functions, and determine placement of each function of the plurality of functions between the plurality of nodes of the communications network; and
an output interface for sending signals to the communications network indicative of each of the plurality of functions and their placement in the communications network.

10. A computer readable memory having recorded thereon statements and instructions for execution by a computer, the statements and instructions comprising:
converting a radio access network (RAN) process into a service function chain having a plurality of functions; and
distributing each function of the plurality of functions between a plurality of nodes in a communications network.

11. A method for configuring a radio access network (RAN) process in a communications network having a plurality of nodes, the method comprising:
generating a Service Function Chain (SFC) descriptor function for defining a SFC having a plurality of functions;
providing the SFC descriptor function to a node in the communications network to convert the RAN process into the SFC according to the SFC descriptor function, and distribute each function of the SFC between the plurality of nodes.

12. The method of claim 11 wherein the SFC descriptor function describes resource requirements for each function of the SFC.

13. The method of claim 11 further comprising receiving parameters from the communications network, wherein the SFC descriptor function is generated in accordance with the parameters.

14. The method of claim 13 wherein the parameters comprise processing or transmission resources of the communications network.
